(19) United States
(12) Patent Application Publication
(10) Pub. No.: US 2026/0066377 A1
(43) Pub. Date: Mar. 5, 2026

(54) SYSTEM FOR DETECTING COOLANT LEAKS IN ELECTRIC VEHICLE BATTERY PACK

(71) Applicant: FCA US LLC, Auburn Hills, MI (US)

(72) Inventors: Gaurav Kumar, Auburn Hills, MI (US); Jianchao Zhu, Auburn Hills, MI (US)

(21) Appl. No.: 18/821,375

(22) Filed: Aug. 30, 2024

(51) Int. Cl. H01M 10/63; B60L 58/26; G01M 3/16; H01M 10/613; H01M 10/625; H01M 10/6554; H01M 10/6568; H01M 50/204; H01M 50/249; H01M 50/271

(52) U.S. Cl. CPC H01M 10/63; B60L 58/26; G01M 3/16; H01M 10/613; H01M 10/625; H01M 10/6554; H01M 10/6568; H01M 50/204; H01M 50/249; H01M 50/271; H01M 2220/20

(57) ABSTRACT

A vehicle including a battery pack having a plurality of battery cells and a battery pack thermal management system configured to exchange heat with the plurality of battery cells. The battery pack thermal management system includes a plurality of cold-plates through which a coolant circulates therethrough for each of the plurality of battery cells, at least one pump for circulating the coolant through the plurality of cold-plates, and controller in communication with the pump. The battery pack includes at least one sensor is configured to generate and communicate to the controller a signal indicative of a change in resistance or capacitance when exposed to moisture, wherein upon receipt of the signal indicative of the change in resistance or capacitance from the at least one sensor, the controller is configured to cease operation of the at least one pump to cease circulation of the coolant through the plurality of cold-plates.

### FIELD

The present disclosure relates to a system for detecting coolant leaks in an electric vehicle battery pack.

### BACKGROUND

This section provides background information related to the present disclosure which is not necessarily prior art.

Electric vehicles rely on complex battery systems for power storage and delivery. To maintain optimal performance, these systems often use coolant for temperature regulation. Coolant leaks, however, can sometimes occur due to a range of factors, necessitating swift detection to prevent damage to the battery cells.

### SUMMARY

This section provides a general summary of the disclosure, and is not a comprehensive disclosure of its full scope or all of its features.

According to a first aspect of the present disclosure, there is provided a vehicle that includes a battery pack including a housing that supports a plurality of battery cells; a battery pack thermal management system configured to exchange heat with the plurality of battery cells, the battery pack thermal management system including a plurality of cold-plates through which a coolant circulates therethrough for each of the plurality of battery cells, and at least one pump for circulating the coolant through the plurality of cold-plates; a controller in communication with the at least one pump; and at least one sensor positioned in the housing that is configured to generate and communicate to the controller a signal indicative of a change in resistance or capacitance when exposed to moisture, wherein upon receipt of the signal indicative of the change in resistance or capacitance from the at least one sensor, the controller is configured to cease operation of the at least one pump to cease circulation of the coolant through the plurality of cold-plates.

According to the first aspect, the housing includes a tray and a lid, and the tray includes an interior surface including a plurality of collection channels for collecting coolant that results from a leak in the battery thermal management system, each of the collection channels being configured to direct the collected coolant to the at least one sensor.

According to the first aspect, the battery pack thermal management system may include a plurality of the sensors.

According to the first aspect, each of the sensors are positioned at a bottom of each of the collection channels, respectively.

According to the first aspect, the tray includes a plurality of through-holes at locations that correspond to the bottoms of the collection channels, and the plurality of sensors are located in the through-holes.

According to the first aspect, the plurality of sensors are accessible and removable from an exterior of the housing.

According to the first aspect, a location of each of the plurality of sensors is stored in the controller.

According to the first aspect, the vehicle may also include a vehicle monitoring system in communication with the controller that is configured to at least periodically receive communications from the controller regarding a status of each of the plurality of sensors.

According to the first aspect, the vehicle monitoring system is configured to generate an alert upon receipt of a communication from the controller that at least one of the sensors has generated the signal indicative of a change in resistance or capacitance when exposed to moisture.

According to a second aspect of the present disclosure, there is provided a vehicle including a battery pack including a housing that includes a tray that supports a plurality of battery cells and a lid attached to the tray, the tray including an interior surface that defines a plurality of collection channels that correspond to each of the plurality of battery cells; a battery pack thermal management system configured to exchange heat with the plurality of battery cells, the battery pack thermal management system including a reservoir having a coolant; a plurality of cold-plates, each cold-plate having an inlet line that provides the coolant from the reservoir to the cold-plate and an outlet line that returns the coolant from the cold plate back to the reservoir, each cold-plate being positioned between a respective battery cell and a respective collection channel; at least one pump for circulating the coolant through the inlet lines, the plurality of cold-plates, and the outlet lines; a controller in communication with the at least one pump; and a valve located in each inlet line and in communication with the controller, the valve in an open position being configured to permit the coolant to travel to a respective cold-plate and in a closed position being configured to prevent the coolant from travelling to the respective cold-plate; and at least one sensor that is configured to generate and communicate to the controller a signal indicative of a change in resistance or capacitance when exposed to moisture, wherein upon receipt of the signal indicative of the change in resistance or capacitance from the at least one sensor, the controller is configured to either cease operation of the at least one pump to stop circulation of the coolant through the plurality of cold-plates or close at least one of the valves to prevent the coolant from reaching a respective cold-plate.

According to the second aspect, the plurality of collection channels are configured to collect coolant that results from a leak in the battery thermal management system, and each of the collection channels are configured to direct the collected coolant to the at least one sensor.

According to the second aspect, a plurality of the sensors may be provided.

According to the second aspect, each of the sensors are located at a bottom of each of the collection channels, respectively.

According to the second aspect, the tray includes a plurality of through-holes at locations that correspond to the bottoms of the collection channels, and the plurality of sensors are located in the through-holes.

According to the second aspect, the plurality of sensors are accessible and removable from an exterior of the housing.

According to the second aspect, a location of each of the plurality of sensors is stored in the controller.

According to the second aspect, after the controller determines the location of the at least one sensor that was exposed to moisture and generated the signal indicative of the change in resistance or capacitance, the controller is configured close the valve associated with the cold-plate that is located over the collection channel where the at least one sensor is located to prevent coolant from flowing to the cold-plate.

According to the second aspect, the vehicle may also include a vehicle monitoring system in communication with the controller that is configured to at least periodically receive communications from the controller regarding a status of each of the plurality of sensors.

According to the second aspect, the vehicle monitoring system is configured to generate an alert upon receipt of a communication from the controller that at least one of the sensors has generated the signal indicative of a change in resistance or capacitance when exposed to moisture.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic representation of an example electric vehicle according to a principle of the present disclosure;

FIG. 2 is a schematic cross-sectional view along line 2-2 of FIG. 1, which illustrates an example battery pack having a battery pack thermal management system according to a principle of the present disclosure;

FIG. 3 is a schematic axial cross-sectional view along line 3-3 of FIG. 1, which illustrates the example battery pack having the battery pack thermal management system according to a principle of the present disclosure;

FIG. 4 is a schematic axial cross-sectional view along line 3-3 of FIG. 1, which illustrates another example battery pack having a battery pack thermal management system according to a principle of the present disclosure;

FIG. 5 is a schematic axial cross-sectional view along line 3-3 of FIG. 1, which illustrates yet another example battery pack having a battery pack thermal management system according to a principle of the present disclosure; and

FIG. 6 is a schematic representation of an example vehicle monitoring system that operates in conjunction with the battery pack thermal management system according to a principle of the present disclosure.

Corresponding reference numerals indicate corresponding parts throughout the several views of the drawings.

### DETAILED DESCRIPTION

Example embodiments will now be described more fully with reference to the accompanying drawings. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

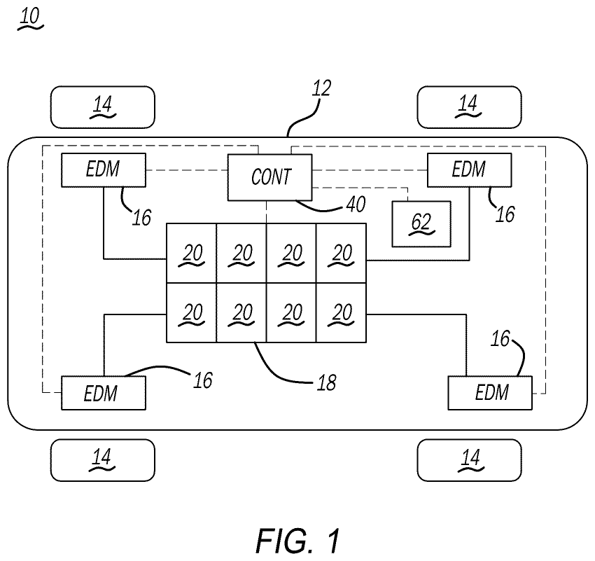

FIG. 1 illustrates an example electric vehicle 10 according to a principle of the present disclosure. Vehicle 10 includes a body 12 and a plurality of wheels 14 that may each be powered by an electric drive motor (EDM) 16 that each receive electric power from a battery pack 18 having a plurality of battery cells 20. While each wheel 14 is illustrated as having a respective EDM 16 associated therewith, it should be understood that vehicle 10 may be a front- or rear-wheel drive vehicle 10 where a single EDM 16 can be used to power either the pair of the front wheels 14 or the pair of rear wheels 14 (i.e., vehicle 10 only includes a single EDM 16), or one EDM 16 can be used to power the pair of front wheels 14 and another EDM 16 can be used to power the pair of rear wheels (i.e., vehicle 10 includes a pair of EDMs 16) without departing from the scope of the present disclosure.

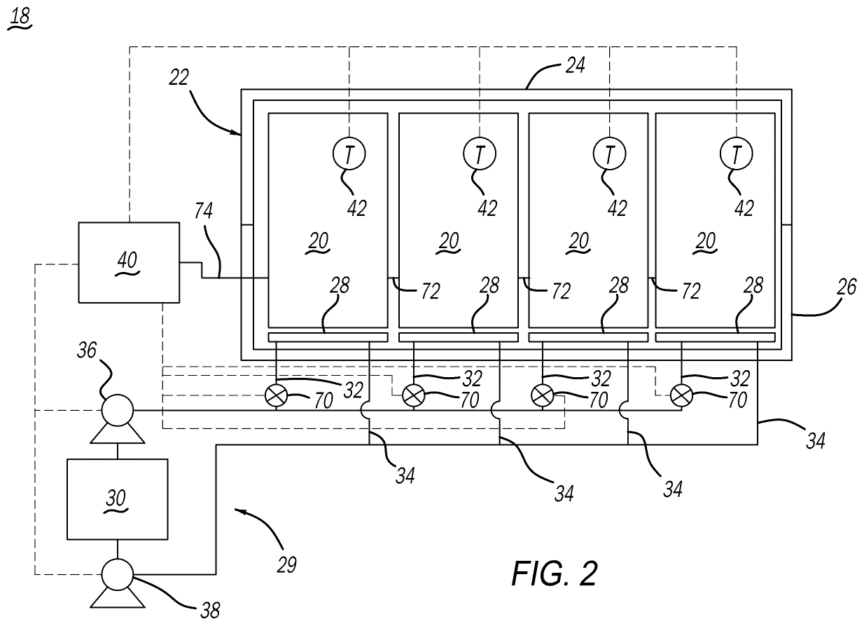

Now referring to FIG. 2, a schematic cross-sectional view of battery pack 18 is illustrated. As can be seen in FIG. 2, battery pack 18 includes a housing 22 having a lid 24 attached to a tray 26, and battery cells 20 are configured to rest on tray 26 with a cold-plate 28 that is part of a battery thermal management system 29 positioned between battery cells 20 and tray 26 that can be used to cool battery cells 20 during operation of vehicle 10. Battery thermal management system 29 includes cold-plates 28, which are hollow structures that receive a coolant from a designated coolant reservoir 30 via inlet lines 32. After coolant passes through cold-plates 28 and exchanges heat with battery cells 20, the coolant exits cold-plates 28 through outlet lines 34 that return the coolant to reservoir 30. An inlet pump 36 may be used to draw coolant from reservoir 30 to cold-plates 28 while an outlet pump 38 may draw coolant from cold-plates 28 back to reservoir 30. Both inlet pump 36 and outlet pump 38 may be in communication with and operated by a controller 40.

Controller 40 may be a vehicle master controller that can control multiple systems within vehicle 10. For example, as shown in FIG. 1, controller 40 is illustrated as being in communication with and configured to control EDMs 16, amongst other systems of vehicle 10. Alternatively, the controller 40 illustrated in FIG. 2 may be a controller that is separate from that illustrated in FIG. 1 (e.g., a battery management system controller), and which is configured to communicate with a vehicle master controller or another controller of vehicle 10. In either case, controller 40 may be used to control operation of pumps 36 and 38 to adjust the amount of cooling that is provided to each battery cell 20. To determine whether to increase or decrease the amount of cooling provided to battery cells 20, it can be seen in FIG. 2 that each battery cell 20 includes a temperature sensor 42 that communicates with controller 40. Temperature sensors 42 generate signals indicative of temperature in battery cells 20, and communicate the signal to controller 40. Based on the signals indicative of temperature transmitted by temperature sensors 42 to controller 40, controller 40 can determine whether to increase or decrease the operating speed of pumps 36 and 38 to increase or decrease the amount of coolant flowing through cold-plates 28, which in turn can increase or decrease the amount of heat exchange with battery cells 20.

Coolant leaks may develop during the useful life of vehicle 10. Inasmuch as the coolant may be generally aqueous in nature (i.e., a mixture of water and glycol), it is generally undesirable that the coolant leaks develop within battery pack 18 from the standpoint that the presence of water can generate a short circuit within battery pack 18. Accordingly, if a coolant leak develops within battery pack 18, the leak should be detected as quickly as possible so that no damage can occur as a result of the coolant leak.

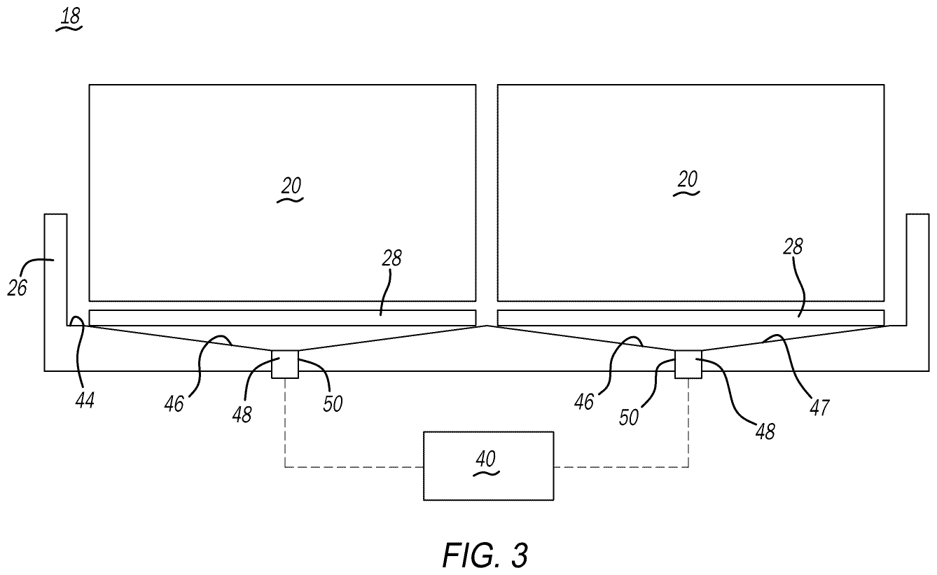

Referring to FIG. 3, it can be seen that tray 26 can include an interior surface 44 that includes a plurality of collection channels 46 that have tapered surfaces 47 formed therein. If a coolant leak develops in any of the cold-plates 28, the coolant can flow along tapered surfaces 47 and collect at a bottom of the collection channel 46. A moisture sensor 48 that can generate signals indicative of moisture can be located at the bottom of each collection channel 46. Moisture sensors 48 may be sensors that generate signals that are indicative of a resistance or capacitance. Put another way, sensors 48 are configured to generate a signal indicative of a baseline resistance or a baseline capacitance when not being exposed to moisture. When sensors 48 are exposed to moisture the sensors generate a signal indicative of resistance or capacitance that has changed (e.g., increased), and this change can be determined by controller 40.

Similar to temperature sensors 42, it can be seen in FIG. 3 that moisture sensors 48 are in communication with controller 40. As will be described in more detail later, if controller 40 receives a signal indicative of resistance or capacitance that indicates the presence of moisture from one of the moisture sensors 48, steps can be taken to identify the location of the potential coolant leak and to mitigate any effects that may occur as a result of the potential coolant leak.

It is preferable that each battery cell 20 have a corresponding collection channel 46 and moisture sensor 48, and the location of each moisture sensor 48 be logged and stored in a memory of controller 40. In this manner, if a particular moisture sensor 48 generates a signal indicative of moisture, the location of the moisture sensor 48 can quickly be identified by controller 40 so that any potential leak that may be located proximate the particular moisture sensor 48 can also be quickly identified.

It can also be seen in FIG. 3 that each moisture sensor 48 is mounted in a through-hole 50 formed in tray 26. Moisture sensors 48, therefore, can easily be attached to and detached from battery pack 18, as needed. This is important from the standpoint that if a moisture sensor 48 is determined to be malfunctioning in any way, it can quickly be identified and replaced. This modular design also allows for quick and cost-effective maintenance because moisture sensors 48 can be accessed without having to remove battery pack 18 from vehicle 10 to access moisture sensors 48.

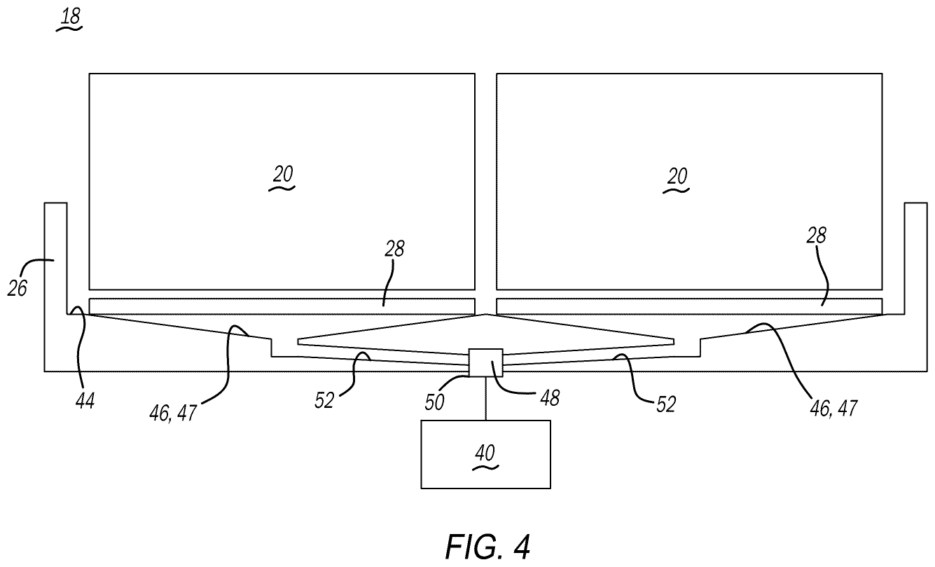

While it is preferable that each battery cell 20 have a dedicated collection channel 46 and moisture sensor 48, it may be desirable from a cost standpoint to utilize only a single moisture sensor 48 to determine whether battery pack 18 is experiencing a coolant leak. In such a configuration, as shown in FIG. 4, each collection channel 46 can communicate with a single moisture sensor 48 that is in communication with controller 40. As can be seen in FIG. 4, a duct 52 may be connected to each collection channel 46 that leads to a single moisture sensor 48. Thus, if a coolant leak develops in battery pack 18, the coolant will flow along tapered surfaces 47 of the respective collection channel 46 before entering the duct 52 and travelling to moisture sensor 48. Similar to the moisture sensors 48 illustrated in FIG. 3, the single moisture sensor 48 can be mounted in a through-hole 50 formed in tray 26 for quick maintenance or replacement if needed.

The combination of collection channels 46 and ducts 52 create a low-level location where coolant from each collection channel 46 can collect, and the single moisture sensor 48 being positioned at a centralized collection point (i.e., where ducts 52 terminate) allows for effective coolant leak detection. In addition, this configuration offers significant cost savings by reducing the need for multiple sensors 48 and associated electrical connections across battery pack 18. Moreover, because this design includes fewer components, a reduction in faults may be observed due to the reduction in connection points.

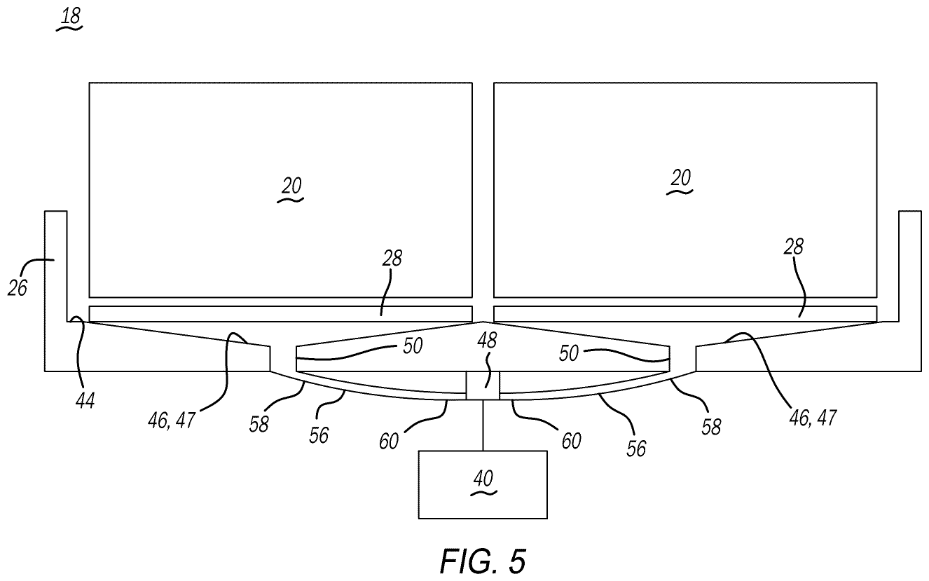

While ducts 52 are illustrated as being provided in the body of tray 26, it should be understood that such a configuration may be more costly to manufacture. It should be understood, therefore, that the tray 26 illustrated in FIG. 3 may be used and the through-holes 50 repurposed. In this regard, referring to FIG. 5, it can be seen that tray 26 still includes through-holes 50 but a moisture sensor 48 is not provided therein. Rather, a single moisture sensor 48 is attached to an exterior surface 54 of tray 26 and flexible tubes 56 extend between the through-holes 50 and the single moisture sensor 48. That is, a first end 58 of tube 56 is attached to through-hole 50 and a second end 60 of tube 56 is attached to moisture sensor 48. Thus, if a coolant leak develops in battery pack 18, the coolant will flow along tapered surfaces 47 of the respective collection channel 46 before entering the tube 56 and travelling to moisture sensor 48. By attaching moisture sensor 48 to exterior surface 54, moisture sensor 48 can still be easily and quickly serviced and/or replaced if necessary. Moreover, by simply attaching flexible tubes 56 between through-holes 50 and moisture sensor 48, costly manufacturing techniques are avoided to form ducts 52.

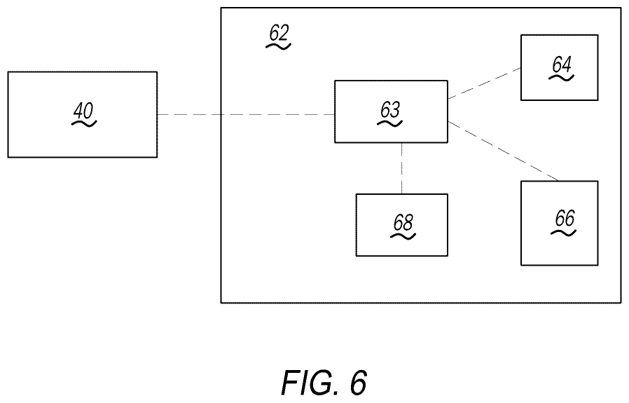

Again referring to FIG. 1 and also referring to FIG. 6, it can be seen that vehicle 10 includes a vehicle monitoring system 62 that communicates with controller 40, and which is configured to provide alerts to occupants of vehicle 10 in the event of a detection of a condition that requires attention. Example systems that can be monitored by vehicle monitoring system 62 include but are not limited to battery pack 18 (e.g., charge remaining), battery thermal management system 29, a vehicle HVAC system (not shown), occupant sensors (not shown) and others. Controller 40, if not a vehicle master controller, may be part of vehicle monitoring system 62. Preferably, however, vehicle monitoring system includes a separate controller 63 that is communication with controller 40.

In the context of the present disclosure, vehicle monitoring system 62 is configured to continually, or at least periodically, receive communications from controller 40 regarding the status of moisture sensors 48. That is, vehicle monitoring system 62 can operate in a diagnostic mode. After controller 40 receives signals indicative of resistance or capacitance form moisture sensors 48, controller 40 can determine whether a moisture sensor 48 has generated a signal indicative of the presence of moisture and communicate this determination to controller 63 of vehicle monitoring system 62 at which time vehicle monitoring system 62 can trigger a notification that alerts an occupant of vehicle 10 (e.g., the driver) that moisture has been detected in battery pack 18. Moreover, if controller 40 does not receive a signal indicative of a change in resistance or capacitance from a moisture sensor 48, controller 40 can determine that the moisture sensor 48 is malfunctioning or defective and communicate this determination to controller 63 of vehicle monitoring system 62, which can then alert an occupant of vehicle 10 that battery thermal management system 29 requires servicing while also indicating which sensor 48 (if a plurality of sensors 48 are being used) appears to be malfunctioning or defective so that the sensor 48 can be repaired or replaced.

The manner in which vehicle monitoring system 62 notifies an occupant of vehicle 10 that moisture is present in battery pack 18 can include a posting a message on a dashboard 64 or infotainment display 66 of vehicle 10, or by illuminating a “battery thermal management system” indicator light 68 located within vehicle 10. Similar messages may be displayed or illuminated if one of the sensors 48 requires repair or replacement.

Vehicle monitoring system 62 can also take steps to mitigate damage to battery pack 18 in the event that a sensor 48 is malfunctioning or generates signals indicative of moisture in battery pack 18. For example, if controller 40 receives a signal indicative of a change in resistance or capacitance that is indicative of moisture being present in battery pack and transmits this determination of vehicle monitoring system 62, controller 63 of vehicle monitoring system 62 can send a signal back to controller 40 that flow of coolant from reservoir 30 to cold-plates 28 should cease. In response to such an instruction, controller 40 can instruct inlet pump 36 to cease operation so that no more coolant is drawn from reservoir 30 to cold-plates 28. Moreover, controller 40 can also cease operation of outlet pump 38 or continue to operate outlet pump 38 for a predetermined amount of time to draw the coolant away from cold-plates 28 so that no additional coolant can leak from battery thermal management system 29. By stopping the flow of coolant through battery thermal management system 29, further leakage and potential damage to the battery pack 18 or other electrical components can be prevented or at least substantially minimized.

In addition, vehicle monitoring system 62 can notify occupants of the vehicle 10 that operation of battery thermal management system 29 has been halted and indicate to the occupants that vehicle 10 will only be permitted to operate for a predetermined amount of time (e.g., 10-20 minutes) before battery pack 18 will be shut down to avoid battery cells 20 from overheating in the absence of thermal management thereof. The amount of time before battery pack 18 is shut down can be determined by controller 40 based on a signal indicative of temperature of battery cells 20 generated by temperature sensors 42. That is, vehicle 10 may be permitted to operate a greater amount of time before shutdown if the temperature of the battery cells 20 is beneath a predetermined threshold.

In the event that battery thermal management system 29 has multiple moisture sensors 48, it may not be necessary to completely halt the flow of coolant. As noted above, when battery thermal management system 29 includes a plurality of moisture sensors 48, the location of each sensor 48 within battery pack 18 can be stored within controller 40 so that if one of the sensors 48 malfunctions or fails, the location can be quickly determined and the sensor 48 easily serviced or replaced. A similar strategy can be used to control thermal management of battery pack 18 in the event that one of the moisture sensors 48 generates a signal indicative of moisture within battery pack 18.

More particularly, again referring to FIG. 2, it can be seen that battery thermal management system 29 includes a plurality of valves 70 located proximate an inlet line 32 of each cold-plate 28 that are each in communication with controller 40. Under normal operating conditions, each of the valves 70 can be maintained in an open position that permits the coolant to pass through the respective inlet line 32, the cold-plate 28, and then into the outlet line 34 to maintain proper cooling of each battery cell 20. If, however, one of the plurality of moisture sensors 48 generates a signal indicative of moisture in a particular cell, controller 40 can quickly determine the location (i.e., cell) where the moisture sensor 48 is located and determine that the valve 70 associated with that battery cell 20 should be closed to prevent additional coolant from leaking at that particular location.

Controller 40 can then send an electrical signal or communication to the respective valve 70 to close, while permitting the remaining valves 70 to remain open and permit coolant to continue providing heat exchange with the remaining battery cells 20. At the same time, controller 40 can potentially shut down the battery cell 20 where leak has occurred, or send a communication to a different controller that can perform this function. In this manner, vehicle 10 may continue to operate and potentially reach a destination before requiring service. Regardless whether vehicle 10 is permitted to continue operation, it should be understood that vehicle monitoring system 62 may still notify occupants of vehicle 10 that battery thermal management system 29 requires service, while also providing the location of the moisture within battery pack 18.

It should also be understood that battery pack 18 is subject to “isolation resistance,” which refers to a measure of electrical resistance between the internal conductive elements of the battery pack 18 (including, but not limited, to its terminals and individual cells 20) and external conductive structures such as a chassis (not shown) that supports battery pack 18 relative to vehicle 10 or the ground. For example, referring to FIG. 2 of the application, it can be seen that each of the battery cells 20 may be electrically connected with one another using bus bars or electrical lead lines 72, and may be in electrical communication with controller 40 via an exterior lead 74. Thus, the isolation resistance may be monitored by controller 40, and monitoring the isolation resistance of battery pack 18 is crucial in evaluating the safety and integrity of battery pack 18, particularly under fault conditions. In addition, isolation resistance quantifies the ability of battery pack 18 to prevent unintended electrical conduction paths that could potentially lead to hazardous conditions such as electric shock or safety failures. A high isolation resistance indicates effective prevention of current leakage from internal components of the battery pack 18 to the external environment, thereby enhancing the operational safety of battery pack 18.

With the above in mind, it should also be understood that if controller 40 determines that there has been a drop in isolation resistance, controller 40 can also determine that an issue may exist in battery pack 18 that requires attention. For example, a sudden drop in isolation resistance can indicate that a seal (not shown) may have failed and permitted moisture to enter housing 22 of battery pack 18, an inadequate build quality of battery pack 18 exists, or a coolant leak exists. In the event of a coolant leak, it should be understood that a coolant leak may not always immediately lower the isolation resistance of battery pack 18. Nonetheless, if one of the moisture sensors 48 generates a signal indicative of moisture and controller 40 also determines that there has been a sudden drop in isolation resistance, the combination of these events may indicate that a severe issue exists that requires immediate attention to maintain the safety and integrity of battery pack 18.

As noted above, vehicle 10 includes a vehicle monitoring system 62 that communicates with controller 40, and which is configured to provide alerts to occupants of vehicle 10 in the event of a detection of a condition that requires attention. Vehicle monitoring system 62 can be configured, therefore, to continually, or at least periodically, receive communications from controller 40 regarding the isolation resistance monitored by controller 40.

After controller 40 determines that there has been a change in isolation resistance that can be indicative of moisture (i.e., a drop in isolation resistance), controller 40 can communicate this determination to controller 63 of vehicle monitoring system 62 at which time vehicle monitoring system 62 can trigger a notification that alerts an occupant of vehicle 10 (e.g., the driver) that moisture has been detected in battery pack 18. The manner in which vehicle monitoring system 62 notifies an occupant of vehicle 10 that moisture is present in battery pack 18 can include a posting a message on a dashboard 64 or infotainment display 66 of vehicle 10, or by illuminating a “battery thermal management system” indicator light 68 located within vehicle 10.

On the other hand, if controller 40 determines that there has been a change in isolation resistance and also receives a signal indicative of moisture from moisture sensor(s) 48, controller 40 can communicate this determination to controller 63 of vehicle monitoring system 62 that a severe condition exists within battery pack 18 that requires immediate attention. At this time, vehicle monitoring system 62 will take steps to mitigate damage to battery pack 18 including, for example, having controller 63 of vehicle monitoring system 62 send a signal back to controller 40 to stop the flow of coolant through battery thermal management system 29 and notifying occupants of the vehicle 10 that operation of battery thermal management system 29 has been halted and indicate to the occupants that vehicle 10 will only be permitted to operate for a predetermined amount of time (e.g., 5-10 minutes) before battery pack 18 will be shut down to avoid potential leakage of current outside of battery pack 18 to exterior components of the vehicle 10.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A vehicle comprising:
a battery pack including a housing that supports a plurality of battery cells;
a battery pack thermal management system configured to exchange heat with the plurality of battery cells, the battery pack thermal management system including a plurality of cold-plates through which a coolant circulates therethrough for each of the plurality of battery cells, and at least one pump for circulating the coolant through the plurality of cold-plates;
a controller in communication with the at least one pump; and
at least one sensor positioned in the housing that is configured to generate and communicate to the controller a signal indicative of a change in resistance or capacitance when exposed to moisture,
wherein upon receipt of the signal indicative of the change in resistance or capacitance from the at least one sensor, the controller is configured to cease operation of the at least one pump to cease circulation of the coolant through the plurality of cold-plates.

2. The vehicle according to claim 1, wherein the housing includes a tray and a lid, and the tray includes an interior surface including a plurality of collection channels for collecting coolant that results from a leak in the battery thermal management system, each of the collection channels being configured to direct the collected coolant to the at least one sensor.

3. The vehicle according to claim 2, further comprising a plurality of the sensors.

4. The vehicle according to claim 3, wherein each of the sensors are positioned at a located at a bottom of each of the collection channels, respectively.

5. The vehicle according to claim 4, wherein the tray includes a plurality of through-holes at locations that correspond to the bottoms of the collection channels, and the plurality of sensors are located in the through-holes.

6. The vehicle according to claim 5, wherein the plurality of sensors are accessible and removable from an exterior of the housing.

7. The vehicle according to claim 6, wherein a location of each of the plurality of sensors is stored in the controller

8. The vehicle according to claim 3, further comprising a vehicle monitoring system in communication with the controller that is configured to at least periodically receive communications from the controller regarding a status of each of the plurality of sensors.

9. The vehicle according to claim 8, wherein the vehicle monitoring system is configured to generate an alert upon receipt of a communication from the controller that at least one of the sensors has generated the signal indicative of a change in resistance or capacitance when exposed to moisture.

10. A vehicle comprising:
a battery pack including a housing that includes a tray that supports a plurality of battery cells and a lid attached to the tray, the tray including an interior surface that defines a plurality of collection channels that correspond to each of the plurality of battery cells;
a battery pack thermal management system configured to exchange heat with the plurality of battery cells, the battery pack thermal management system including:
a reservoir having a coolant;
a plurality of cold-plates, each cold-plate having an inlet line that provides the coolant from the reservoir to the cold-plate and an outlet line that returns the coolant from the cold plate back to the reservoir, each cold-plate being positioned between a respective battery cell and a respective collection channel;
at least one pump for circulating the coolant through the inlet lines, the plurality of cold-plates, and the outlet lines;
a controller in communication with the at least one pump; and
a valve located in each inlet line and in communication with the controller, the valve in an open position being configured to permit the coolant to travel to a respective cold-plate and in a closed position being configured to prevent the coolant from travelling to the respective cold-plate; and
at least one sensor that is configured to generate and communicate to the controller a signal indicative of a change in resistance or capacitance when exposed to moisture,
wherein upon receipt of the signal indicative of the change in resistance or capacitance from the at least one sensor, the controller is configured to either cease operation of the at least one pump to stop circulation of the coolant through the plurality of cold-plates or close at least one of the valves to prevent the coolant from reaching a respective cold-plate.

11. The vehicle according to claim 10, wherein the plurality of collection channels are configured to collect coolant that results from a leak in the battery thermal management system, and each of the collection channels are configured to direct the collected coolant to the at least one sensor.

12. The vehicle according to claim 11, further comprising a plurality of the sensors.

13. The vehicle according to claim 12, wherein each of the sensors are located at a bottom of each of the collection channels, respectively.

14. The vehicle according to claim 13, wherein the tray includes a plurality of through-holes at locations that correspond to the bottoms of the collection channels, and the plurality of sensors are located in the through-holes.

15. The vehicle according to claim 14, wherein the plurality of sensors are accessible and removable from an exterior of the housing.

16. The vehicle according to claim 15, wherein a location of each of the plurality of sensors is stored in the controller.

17. The vehicle according to claim 16, wherein after the controller determines the location of the at least one sensor that was exposed to moisture and generated the signal indicative of the change in resistance or capacitance, the controller is configured close the valve associated with the cold-plate that is located over the collection channel where the at least one sensor is located to prevent coolant from flowing to the cold-plate.

18. The vehicle according to claim 12, further comprising a vehicle monitoring system in communication with the controller that is configured to at least periodically receive communications from the controller regarding a status of each of the plurality of sensors.

19. The vehicle according to claim 18, wherein the vehicle monitoring system is configured to generate an alert upon receipt of a communication from the controller that at least one of the sensors has generated the signal indicative of a change in resistance or capacitance when exposed to moisture.
